(19) United States
(12) Patent Application Publication
(10) Pub. No.: US 2016/0203498 A1
(43) Pub. Date: Jul. 14, 2016

(54) SYSTEM AND METHOD FOR IDENTIFYING AND SCORING LEADS FROM SOCIAL MEDIA

(71) Applicant: LEADSIFT INCORPORATED, Halifax (CA)

(72) Inventors: Tapajyoti DAS, Halifax (CA); Jacek WOLKOWICZ, Halifax (CA); Sreejata CHATTERJEE, Halifax (CA); Hatem NASSRAT, Halifax (CA); Daniel ALLEN, Halifax (CA)

(21) Appl. No.: 14/915,027

(22) PCT Filed: Aug. 28, 2014
(86) PCT No.: PCT/CA2014/000647

§ 371 Date: Feb. 26, 2016

Related U.S. Application Data
(60) Provisional application No. 61/870,810, filed on Aug. 28, 2013.

(51) Int. Cl. G06Q 30/02; H04L 29/08; G06Q 50/00; G06F 17/30

(52) U.S. Cl. CPC G06Q 30/0201; G06F 17/30675; H04L 67/02; G06Q 50/01

(57) ABSTRACT

A system and method for identifying and scoring leads from social media. The method includes Identifying a lead by performing a semantic analysis of a data item disseminated by the lead via the web-enabled medium including by applying a taxonomy generated in accordance with a predefined topic to determine that the data item is related to the topic. The method then scores the data item in relation to the topic based upon a lead scoring process including by an analysis of additional historical data items disseminated by the lead.

### TECHNICAL FIELD

The following relates generally to business sales lead generation and more specifically to lead generation based on content obtained from social media.

### BACKGROUND

Every day millions of conversations are happening on social media, including conversations in which people express intent about different products and services. Conversation can be also found across the web in the form of blogs, microblogs, product reviews, forums, etc.

This has resulted in an environment where the public can express their personal opinion about events, products, organizations and people. A significant portion of social media posts express needs and concerns relating to products and services, including in relation to sales, advocacy and customer relations.

Several prior techniques exist for mining social data to identify sentiment/opinion trends and brand mentions. These are typically based on simple keyword lookup for identifying purchase intent, but this technique can be time consuming and not exhaustive.

User intent identification typically covers mostly search engine queries, which typically contain very few terms, and are not organized in the form of a sentence.

### SUMMARY

In one aspect, a method of scoring a lead for engagement through a web-enabled medium is provided, the method comprising: (a) identifying a lead by performing a semantic analysis of a data item disseminated by the lead via the web-enabled medium including by applying a taxonomy generated in accordance with a predefined topic to determine that the data item is related to the topic; and (b) scoring the data item in relation to the topic based upon a lead scoring process including by an analysis of additional historical data items disseminated by the lead.

In another aspect, a method of scoring a lead for engagement through a web-enabled medium is provided. The method comprises: (a) identifying, in a data item disseminated by a user via the web-enabled medium, an intent by semantically analysing the data item and verifying whether the semantically analysed data item matches a pattern model for a topic; and (b) assigning a score to the lead based at least on the intent. The method may further comprise assigning the score to the lead further based on an analysis of historical data items disseminated by the user.

In still another aspect, a system for scoring a lead for engagement through a web-enabled medium is provided. The system comprises: (a) an intent identification module linked to the web and configured to: identify, in a data item disseminated by a user via the web-enabled medium, an intent based on a topic by semantically analysing the data item and verifying whether the semantically analysed data item matches a pattern model; store, in association with the lead, at least the data item and the identified intent for the data item in a scored items database; and (b) a lead scoring module, linked to the scored item database, configured to assign a score to the lead based at least on the intent. The lead scoring module may be configured to assign the score to the stored lead further based on an analysis of historical data items disseminated by the user.

In yet another aspect, a method for scoring a lead for engagement through a web-enabled medium comprises: (a) identifying, in a data item disseminated by a user via the web-enabled medium, an intent based on a topic by performing a semantic analysis of the data item; and (b) assigning a score to the lead based at least on intent.

In a still further aspect, a system for scoring a lead for engagement through a web-enabled medium comprises: (a) an intent identification module linked to the web and configured to: identify, in a data item disseminated by a user via the web-enabled medium, an intent based on a topic by performing a semantic analysis of the data item; and store the data item and intent for the data item in a scored item database; and (b) a lead scoring module, linked to the scored item database, configured to assign a score to the lead based at least on the intent.

In other aspects, systems and methods of identifying and scoring leads from social media are provided.

### BRIEF DESCRIPTION OF THE DRAWINGS

The features of the invention will become more apparent in the following detailed description in which reference is made to the appended drawings wherein:

FIG. 1 is a block diagram of a system for identifying and scoring leads from social media;

FIG. 2 is a flowchart depicting exemplary processes of intent identification;

FIG. 3 is a flowchart depicting scoring of leads for which intent has been identified;

FIG. 4 is an exemplary detail screen viewable by a business in relation to a lead.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any engine, unit, module, component, server, computer, terminal or device exemplified herein that executes instructions may include or otherwise have access to computer readable media, such as, for example, storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as, for example, computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media. Such engine, unit, module, component, server, computer, terminal or device further comprises at least one processor for executing the foregoing instructions.

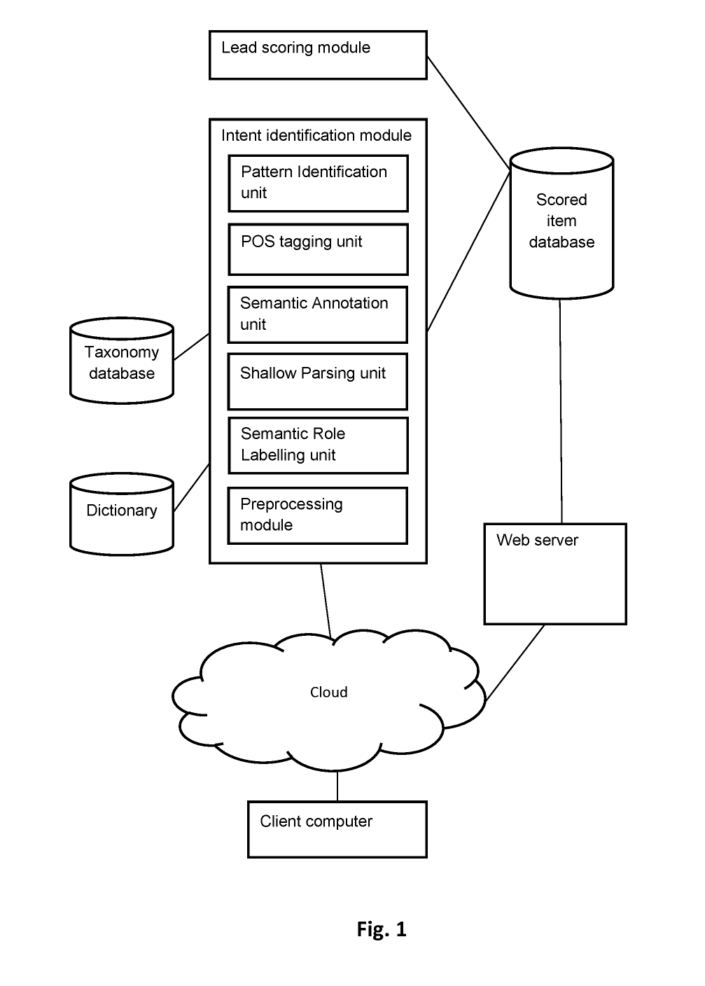

The following provides a system and method for identifying and scoring leads from social media. Referring first to FIG. 1, a system linked to the cloud (a network, such as the Internet) comprises an intent identification module and a lead scoring module. A taxonomy database linked to the intent identification module stores a lexical taxonomy. A scored item database linked to the lead scoring module and the intent identification module stores data items as being identified leads and, subsequently, scored leads, wherein each lead is linked to an identifier for its corresponding user, the user being the author of the data item. A dictionary is linked to the intent identification module. A web server may be provided and linked to the cloud for delivering scored leads to a subscribing business, which may access the leads via a client computer.

The system obtains a plurality of social media data items from the cloud (as provided by a plurality of users), identifies intent in each such item with respect to a plurality of topics, and assigns a score to each such item in respect of each of the topics. The leads and their related scores may be refined based on a set of constraints and exceptions. The data item is linked to a user identifier, wherein the user is the author of the data item.

In one aspect, the intent identification unit comprises a preprocessing module. The preprocessing module obtains the data items in real-time as they are generated and disseminated across the cloud. The intent expressed in the item may subsequently be identified and scored with reference to predefined topics. Topics may, for example, relate to the purchase stage of specific consumer activities associated with items. The scored items may be provided to businesses for future engagement with potential customers, being the user associated with the data item and/or a target group for which the user is a representative example. Topics may alternatively, in another example, relate to the purchase stage for a consumer irrespective of specific items which the consumer may be interested in. These are just two exemplary sets of topics; however, topics could relate to any other aspect or characteristic obtainable from social media data items.

In another aspect, the intent identification module comprises a shallow parsing unit operable to isolate groups of tokens representing a single concept, i.e. phrases and the head of each phrase to determine applicability of intent towards topics that are related to the phrase head.

In a further aspect, the intent identification comprises a pattern identification unit operable to identify intent for a data item by determining whether the data item matches matching rules for a desired pattern model. A set of exceptions may further be applied using the matching rules.

In yet another aspect, the lead scoring module is operable to assign a score to the data item, for which intent has been identified, based on the topic which again, for example, may relate to the purchase stage of the consumer for a particular product or service. An example of differentiation of intent for a common topic is a consumer's intent of “need a car” versus “going car shopping”, with the former having a lower score than the latter.

In a yet further aspect, the lead scoring module is operable to refine intent and score for the topic on the basis of historical posts associated with the consumer. Further refinements may be provided, comprising intent strength, temporal aspect, social media features, domain-specific scoring and use of slangs/abuses.

In an additional aspect, the intent identification module is linked to a taxonomy database storing a lexical taxonomy. The taxonomy is generated to link words and phrases relating to common topics. The taxonomy is generated based on knowledge of the predefined topics; that is, the links are intelligently made so that they assist in the evaluation of leads against the predefined topics. For example, topics may be business topics, wherein each business topic is a specific predefined business vertical. In this case, the taxonomy relates words and phrases of the specific predefined business verticals that may be closely linked so that a business can mine scored leads by selecting one of the verticals, rather than by merely selecting or entering free form keywords. Alternatively, the topics may relate to purchase readiness of consumers irrespective of particular business verticals of interest to those consumers. Such readiness may be indicative, for example, of the consumer being prepared to make purchases in general or simply for having disposable income generally.

The taxonomy may be generated automatically, manually, or both. For example, a collection of information (such as an online repository or domain specific website) may be processed to generate the taxonomy. In this case, keywords may be mapped according to the vertical, for example. In a specific example, for the business vertical of automobile sales and servicing, keywords may comprise makes, models, parts or services, whereas, with telecoms, keywords may comprise providers of phone, internet, cable and hardware such as mobile phones and satellite dishes. For example, “I want an iPhone™” may be a buying lead for a wireless telephone provider but of little or no value to a cable telephone provider, whereas, “I hate my cable” may be a churn/customer service lead for a cable television provider but of little or no value to a telephone provider. The example may further indicate a lead generally, where the topics relate to purchase readiness. Manual links in the taxonomy may also be generated by an administrator of the taxonomy.

In another example, the taxonomy may be generated using a core set of key-phrases for each topic (e.g., each business vertical) and then augmenting the core set of key-phrases with category information obtained from, for example, publicly available websites, to iteratively expand them. For example, in a telecom vertical, the core set may comprise names of popular mobile phones models. Category information may then be obtained from website articles (e.g., from Wikipedia™) corresponding to these models and then further related articles with the same category. In an example, from an article for iPhone™, the category information: Smartphones, Mobile phones, Touchscreen phones, Apple mobile phones, etc. may be obtained and linked in the taxonomy, and then other articles may be obtained, analyzed and phrases linked.

The taxonomy may further comprise social media handles (e.g, user names) such as those associated with businesses. For example, a business, Bob's Hardware, may have a Twitter™ handle for customer support of “©BobsHardware” and this handle may be linked in the taxonomy. Thus, when consumers include handles in social media data items, the handle may be used as an indicator of intent.

The preprocessing module is operable to perform preprocessing on data items obtained from the cloud. The preprocessing module prepares the data items for intent identification by the intent identification module. Preprocessing may comprise tokenization, normalization and spell-checking.

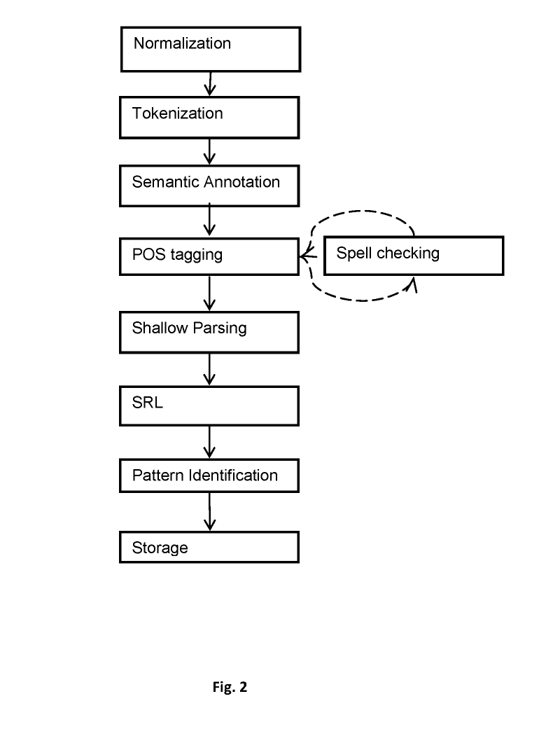

In operation, with reference to FIG. 2, the pre-processing unit tokenizes data items. Tokenization identifies and separates an obtained data item into granular semantic units referred to herein as tokens. For any particular data item, the preprocessing module breaks down the input flow of text included in the data item into words and other components of text, such as punctuation, contractions, or emoticons. The preprocessing module may implement a tokenization technique provided, for example, by the Natural Language Toolkit™ (NLTK). NLTK is operable to provide two-tier tokenization comprising tokenization of text into sentences and sentences into tokens. Other tokenization techniques implementable by the preprocessing module comprise MST parser, CMU ARK parser, NLPNet, etc. Alternative techniques may be provided for languages where, for example, words may not be typically separated by spaces as in the English language.

Preferably, the preprocessing module implements a tokenization technique that can tokenize text containing abbreviations, colloquialisms, conventions, identifiers (such as, for example, hashtags and reply symbols) and graphical or text-based symbols such as emoticons, for example, that may be present in social media data items.

Normalization may comprise, for example, lower-casing of text, stripping of punctuation, expansion of common abbreviations to a proper phrase, replacement of non-ASCII characters, etc.

Following tokenization, the intent identification module is operable to perform intent identification for a data item in respect of each of the predefined topics. For each such topic, intent identification may comprise semantic analysis, grouping, exception handling, topic dependence, and classification.

The intent identification module may further comprise a semantic annotation unit, a parts-of-speech (POS) tagging unit, a shallow parsing unit and a semantic role labeling unit to provide semantic analysis.

Semantic annotation comprises defining particular keywords as representing groups of words having substantially the same meaning using a domain specific ontology, such as a taxonomy stored in the taxonomy database. This allows building rules that would accept a class of terms, rather than merely a single term. Without limitation, examples of these particular keywords comprise, for the sentence “I want to buy a car”, for example:
want can be any word of: want, need, have, . . . .
buy can be any word of: buy, purchase, get, . . . .
car can be any word of: car, truck, van, and all the concepts from the taxonomy similar in the meaning to any car type, brand or name.

Therefore, the sentence “I want to buy a car” may be classified as belonging to the same superclass as the sentences “I have to buy a car”, “I have to purchase a van”, and other variations. It is apparent, then, that variations of sentences and phrases will be present, each expressing substantially similar sentiment of substantially similar value to a business. The semantic annotation unit applies a tag to keywords to link each keyword to its related taxonomy.

Part-of-speech (POS) tagging is the process of marking up a word in a text (corpus) as corresponding to a particular part of speech, based on both its definition and its context. POS tagging provides basic syntactic and semantic information about words in a sentence. Unlike tokenization, this task typically requires more resources, and different part-of-speech taggers vary in sophistication and speed. The POS tagging unit may apply POS tagging using a known general purpose POS tagging technique. NLTK is one example, though others may be provided. Further, the POS tagging unit may be trained using training tools, such as, for example, NLPNet.

Given the nature of social media data items, often many words are misspelled (whether intentionally or not) which not only results in the lack of recognition of their meaning, but can also corrupt the processes of tokenization and POS tagging. The intent identification module may therefore provide spell-checking to mitigate the effects of misspelling and consequent corruption of tokenization and POS tagging. An example of a spell-checking technique that may be provided is, for example, the pyEnchant™ technique, which provides basic spell checking capabilities to determine if a word is in a dictionary and offers suggestions for misspelled words. In embodiments, the intent identification module may selectively enable spell-checking, based on achieving a minimum confidence level of the existing amount of tagging obtained, for example, to minimize extraneous processing load.

In an alternate aspect, the POS tagging unit tags the sentence and the intent identification module next searches the sentence for words tagged as unknown (or untagged). The spell checking unit processes the unknown words by, for example, determining whether they appear in the dictionary. The spell checking unit replaces each unknown word, determined by the POS tagger as a foreign word, with its most likely replacement. The output of the spell-checking unit is passed through the POS tagger again and the result may be treated as final. Thus, although this aspect may be computationally expensive, it reduces inaccuracies in the post that might otherwise result in incorrect POS tagging.

The POS tagging unit passes the POS tagged sentence to the shallow parsing unit. While typical textual data linguistic analysis techniques apply full parsing to sentences, that approach may not provide optimal results. There are at least two reasons for this. First, with typically noisy and error-filled text, accurate parsing is not easily achievable, and typically parsing needs to be near perfect to not confuse analysis. Second, unlike POS tagging, full parsing is computationally intensive.

However, it has been found that by shallow parsing (also referred to as “phrase identification” or “chunking”), instead of full parsing, additional useful information may be generated from a sentence while reducing computational load. Shallow parsing separates a sentence marked using POS tags into phrases such as verb phrases, noun phrases, etc.

The shallow parsing unit is operable to generate information about phrases to identify phrase heads. The shallow parsing unit identifies heads of verb and noun phrases by using the last word of the first continuous passage of a relevant part of speech tags, being nouns and verbs, respectively. For example, in the sentence “1 really need to buy a new car”, the term ‘car’ is not only a keyword in the auto topic, but also a head of a phrase “a new car”. In another example, if the sentence is “1 really need to buy a new car charger for my phone”, the topic is ‘chargers’, because the head of the phrase is a ‘charger’, not the ‘car’ itself.

The semantic role labelling unit then applies semantic role labeling (SRL) to determine an action and arguments present in an overlying syntactic structure of a sentence with frames. For example, in the sentence “1 want to buy a car”, VERB(want) takes two arguments: SUBJECT(I) and OBJECT(to buy a car), and VERB(buy) takes SUBJECT(I) and OBJECT(a car), where in both cases a keyword car is an object of interest for this pattern. SRL enables the application of additional constraints to rules that confirm the fitting of a sentence to a pattern from a sentence structure perspective.

In one aspect, the pattern identification unit is configured with a set of matching rules. The pattern identification unit may therefore provide a unification based approach using regular expressions. To use regular expressions, the pattern identification unit may apply a bracketed representation for each word. The bracketed representation contains information on all the analyzed linguistic levels as determined in one or more of semantic annotation, POS tagging, shallow parsing and semantic role labelling, as previously described.

An exemplary bracketed representation is as follows:
<POS|#TAG##TAG2# . . . #TAGN#|PHRASE|SRL|OPTIONS|WORD>
   where:
POS is a part of speech, such as NN, VB, JJ etc.;
TAG is any semantic tagging associated with the current word, wherein each tag is enclosed with # symbols, and all tags are sorted alphabetically, so that it is possible to prepare a regular expression to match multiple tags at once;
PHRASE is the identifier of a phrase a word belongs to;
SRL defines SRL frame classes to which each token belongs;
OPTIONS are special functional characteristic of the given word, wherein, for example, ‘h’ may be used to identify heads of noun phrases, ‘g’ may be used to identify heads of verb phrases (conversely, ‘f’ (or foot) represents ‘not head’), ‘+’ or ‘-’ may be used to identify positive or negative context in which the word appears, wherein negative contexts may be triggered by the presence of one of the NOT keywords present within certain phrase (such as not, don't, etc.); and
WORD is the token itself in plain text, i.e., as it appeared in the obtained data item.
   Further, an underscore ‘_’ indicates features which are not yet determined, and the empty string shown as ‘ ’ for any feature means that no data associated with that feature was found.

The matching rules further enable the matching of tokens to preconfigured desired pattern models. To match any token, the pattern identification unit may, for example, apply the following regular expression:
/<[\w\$]+\|(?:(?:#[\w\.]+#)*|\_)\|\w*\|\(?:(?:[hfg]?[+−]?)|\_)\|\S+?>/

From the above expression, the pattern identification unit may begin to build bigger building block tokens satisfying certain conditions. For example, the following regular expression may be used to match any noun (NN), belonging to word category AUTO (tag #AUTO#), and being the head of the phrase (h):
<NN\|(?:\#[w\.]+\#)*\AUTO\#(?:\#[\w\.]+\#)*\−\w*\|h[+−]?\|\S+?>

The pattern identification unit next concatenates the regular expressions for different words (tokens). The pattern identification unit may be preconfigured with a set of desired pattern models, which can be modelled based upon the types of intent relevant to the business. For example, a desired pattern model may be modelled to locate data items implying the author ‘wants’ a ‘car’. The matching (or unifying) of regular expressions to desired pattern models means that the text unified with a regular expression returns an instantiated lead matching the pattern. For instance, the sample sentence “1 want to buy a car” may be parsed into the following, where whitespaces and newlines are added for clarity:

<PRP |#FP##|WE##PRP# #SW# |NP01|S0S1|h+|l >
<VBP |#CANT_WAIT# #NEED# #SW##WANT#|VP02|V0 | +|want>

| | |
|---|---|
| <TO \|#PP# | #SW# \|VP02\|O0 \| +\|to > |

<VB |#BUY##TRADE_AUTO# |VP02|O0V1|h+|buy >
<DT |#DET##SINGLE_OBJECT# #SW# |NP03|O0O1| +|a >
<NN |#AUTO_TYPE##_KEY_auto# |NP03|O0O1|h+|car >

| | |
|---|---|
| <PUNC\| | \| \| \| +\|. > |

The foregoing would match a desired pattern model such as, for example, one denoted as (‘+WANT’, 1, ‘BUY’, 4, ‘h % ks’) which is as follows:

```
(?P<token1><(?P<pos1>[\w\$]+)\|(?:#[\w\.]+#)*#(?P<kwd1_0>(?:WANT))#(?:#[\w
      \.]+#)*\|(?P<phrase1>\w*)\|(?P<srl1>\w*)\|(?P<options1>[hfg]?\+)\|(?P<word1>
      \S+?)>)
(?:<[\w\$]+\|(?:(?:#[\w\.]+#)*|\_)\|\w*\|\w*\|(?:(?:[hfg]?[+−]?)|\_)\|\S+?>){0,1}?
(?P<token2><(?P<pos2>[\w\$]+)\|(?:#[\w\.]+#)*#(?P<kwd2_0>(?:BUY))#(?:#[\w\.]
      +#)*  \|(?P<phrase2>\w*)\|(?P<srl2>\w*)\|(?P<options2>[hfg]?[+−
      ]?)\|(?P<word2>\S+?)>)
(?:<[\w\$]+\|(?:(?:#[\w\.]+#)*|\_)\|\w*\|\w*\|(?:(?:[hfg]?[+−]?)|\_)\|\S+?>){0,4}?
(?P<token3><(?P<pos3>[\w\$]+)\|(?:#[\w\.]+#)*#(?P<kwd3_0>(?:_KEY_auto))#(?
      :#[\w\.]+#)*  \|(?P<phrase3>\w*)\|(?P<srl3>\w*)\|(?P<options3>h[+−
      ]?)\|(?P<word3>\S+?)>)
```

It should be understood that the foregoing regular expression and desired pattern model formats are exemplary in nature only, and could be prepared in any like manner sufficient to enable the matching of intent in sentences to any desired pattern.

Matching rules may further comprise one or more exceptions, constraints and verification functions, which operate similarly to desired pattern models. Exceptions may be evaluated only when a candidate lead is found and are verified for a particular rule. If the rule matches the exception, the candidate lead may be discarded.

Constraints may be added to a rule, which are not captured, or are hard to capture, using regular expression unification. Exemplary rules may comprise:
1—accept without additional constraints;
function—apply this constraint function and decide if it is lead or not;
[ . . . ]—succeed only if ALL elements of the list are satisfied (AND operator). The elements could be, for example:
   function—evaluate this function for the verification;
[ . . . ]—succeed if ANY of the function in the list are satisfied (OR operator);
Exemplary rules may further comprise any combination of the above rules.

A verification function is a function that accepts two arguments and returns a match (from the pattern) being true or false. True matches may be considered verified leads while failure corresponds to lead rejection. Exemplary verification functions comprise:
phrase_max_sep(1st_kwd_id, 2nd_kwd_id, max_separation)—ensures that 1st and 2nd keywords from the rule are at most max_separation phrases apart
not_only_past( )—ensures that there are other tenses than only past in the tweet
sentiment around(token_id, sentiment threshold, phrase_limit, token_limit)—ensures a certain degree of positive or negative sentiment is present within limits defined by phrase_limit and/or token_limit, in the context defined by a token identifiable by token_id.
match_frames(srl, . . . )—all of the srl descriptors must match (only if srl info available):
   an srl descriptor is either to match a specific position on the rule:
      <pos><role><keyword_id><options>
      where:
         pos—a position of a keyword in the rule
         role—SRL role to be assumed for a token (from available pos roles, e.g., S, V, O, A, . . . ) or ‘.’ for any role but within the recognized SRL structure
         keyword_id—if this particular token was using multiple choice of keywords to match a token at particular position in the rule
         options—add ‘?’ if upon failure of the particular constraint you want to ignore it.
   or to match any keyword within the sentence to satisfy the condition:
      <role><custom_keyword><options>
      where:
         custom_keyword—keyword from the semantics to match specific role, typically ‘FP’ for first person
         options—similarly, set if you want a failure in this particular requirement let it succeed, if the token is not found.

For example, the following forms a complete rule to match, rather strictly, “I want to buy a car” post:
(‘+WANT’,1, ‘BUY’, 4, ‘h % ks’), [match_frame(‘SFP?’, ‘1V’, ‘2O’, ‘3O’), match_frame(‘SFP?’, ‘2V’, ‘3O’)]

Desired pattern matching may be configured separately for various business verticals, as many patterns will be domain specific, and even common patterns behave differently from one domain into the other, specific rules are tweaked using heuristics, for each vertical separately.

The intent identification module, therefore, is operable to define, for each of a set of predefined topics, a lead from a social media data item made by an author (a user) with whom a business might wish to engage. The intent identification module, by use of the desired pattern matching rules, may classify such leads among a plurality of categories. Exemplary categories, for example, may comprise buying leads, churn/customer service leads and fans/brands advocates. The intent identification module achieves categorization using selected keywords (determined by an administrator of the system, a business, heuristics, or a combination thereof).

A buying lead may be defined by a user expressing intent to purchase a product/service. Exemplary keywords applicable for such a category comprise, for example, buy, need, want, shopping, saving up etc.

A churn/customer service lead may be defined by, for example, a user expressing dissatisfaction with a product/service (e.g. “hate XCo online support”) or contemplating terminating an existing contract (e.g. “that's it XCo I am switching to YCo”). In an example, keywords expressing polarity (e.g. hate, sucks, unhappy, etc.) and common churn patterns (e.g. cancelling, terminating, etc.) may be applied to identify churn/customer service leads. The unintended impact of such keywords may be mitigated by previously described SRL to ensure the correct sentiment is associated with the product/service in context. For example, the sentence “I hate the bus ride—now talking to TelCo support” may be processed through SRL to ensure that the data item is not identified as a churn/customer service lead for TelCo.

A fan/brand advocate may be defined by a user expressing positivity or interest about a product/organization. For example: If a user is passionate about hockey and mentions that on social media, the intent identification module may identify that user as a fan, or if a user expresses positivity about his/her experience with a product/brand, that user may be identified as a brand advocate. The intent identification module may identify a fan using, for example, a combination of data items from the user, biographical data (e.g., do they explicitly mention their allegiance) and social network information (do they follow brands/organizations). The taxonomy may then be used to extract and infer implicit information about the user's preferences and interests for fan identification. For example if a user expresses: “Life long 49ers” in their bio, the ‘49ers’ keyword may be extracted and associated with football to infer the user is a football fan.

Following intent identification, verified leads may be stored to the scored item database. Each stored lead may comprise the raw and tokenized data item along with any identified associations and other tags. The data item is further linked to an identifier for the author (user).

Subsequently, leads may be scored to further refine suitability for engagement by businesses. The lead scoring module is operable to perform lead scoring for a data item in respect of a topic. Once the intent identification module determines intent for the data item in respect of the topic, lead scoring refines the intent to a more specific stage of the buying cycle.

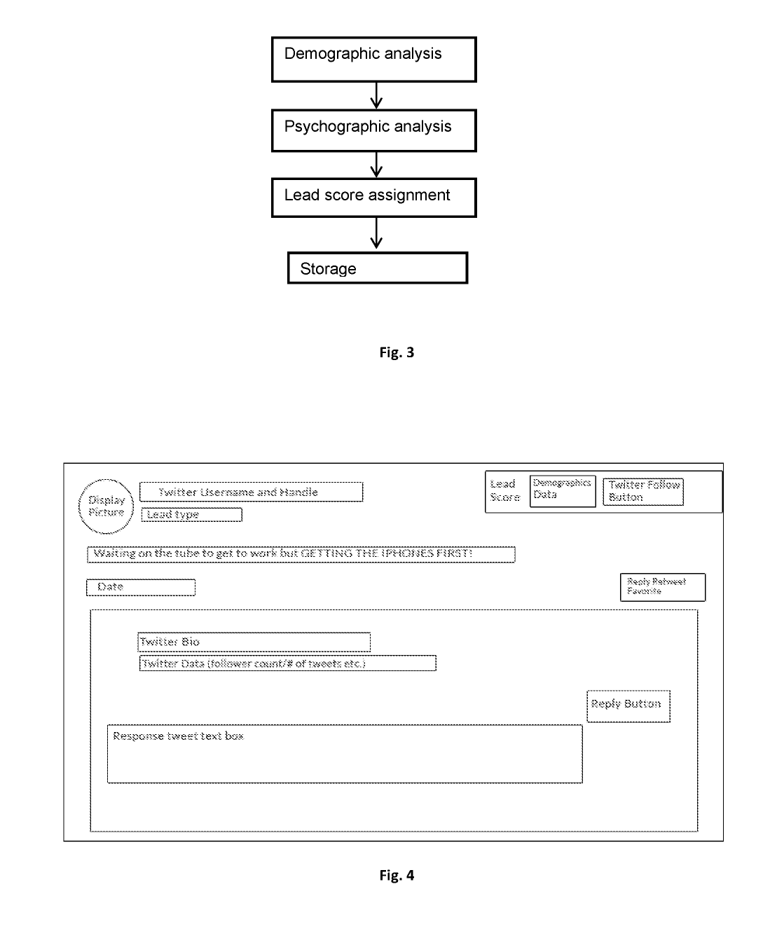

Referring now to FIG. 3, the lead scoring module is operable to score a data item based on scoring factors comprising historical analysis of prior data items from the user and lead score assignment.

Historical analysis of prior data items may comprise demographic and psychographic data extraction on data items for which historical data items are accessible, given the particular social network.

The lead scoring module is operable to analyze and infer demographics information from a user's biography, historical posts and social vicinity. The lead scoring module extracts and analyzes each such historical post and processes it against a set of preconfigured keywords indicative of demographic factors. Exemplary demographic information that may be extracted comprises, for example, gender, parent, owner of a house, owner of a car, pet owner and person with a job (including specific profession if obtainable). Any other demographic information may also be extracted. Keywords are those which are indicative of these types of information.

For example, if a user posts: “Going to pick up my kids from school”, the lead scoring module may identify key phrases such as “my kids” to infer that the author of the post is a parent. Going one step further, if it can be determined, through additional application of the lead scoring module, that the author is a female/male then the author may be identified and labelled as a mother/father, respectively.

In another example, if a user posts “Looking for a new car. Any suggestions?” and from our demographics information it can be determined that the author of the post has kids and is a pet owner then they can be engaged with sales of an SUV/Mini-Van rather than a small sized car.

Similarly, the lead scoring module is operable to process historical posts for psychographic extraction. Using a combination of machine learning techniques and taxonomy information the interests of a user from their historical posts can be identified. The machine learning techniques may comprise rule-base machine learning methods enabling the analysis of historical posts to build a vector representation of the user profile and compare similarity against topic keywords, or supervised machine learning algorithms such as Naive Bayes, Support Vector Machine and Maximum Entropy. Taxonomy information may comprise for each of the topic interests (e.g. sports, business, politics etc.) a taxonomy of key-phrases from publicly available repositories.

For example, if a hotel business knows that a potential customer looking to book a hotel is interested in outdoor sports they can tailor their message with a link to their complimentary scuba-diving lessons page. A message may consist of, for example, an ad unit or a one-to-one communication directed to the potential customer.

Lead score assignment combines a plurality of signals to assign a score to a user for the topic. Signals may comprise, for example, intent strength, temporal aspect, social media features, domain-specific scoring and use of slangs/abuses.

Intent strength corresponds to the buying stage of the user. A preconfigured matrix mapping intent patterns present in data items to a buying stage of a consumer may be used to determine intent strength. There may be a plurality of such intent patterns for any particular business vertical. Exemplary intent patterns may be found in the example “Hate waiting for the bus, that why I need a car” being very early in the buying stage and having low intent strength, while “Car shopping begins! #excited” indicates further along in the buying stage of the user and scored being higher.

Temporal aspect enables a further refinement of score. If a data item contains, or can be determined to refer to, a specific temporal aspect relating to a future purchase behaviour, that information may be used to increase or decrease the score. For example, if a user posts “Phone contract is over, new phone next month Yayy!” the temporal aspect in the post enables the post to be scored accordingly. If the temporal aspect was more immediate, in contrast, the score may be higher.

Social media features may be used as a refinement applicable based on the particular social network (and corresponding social network capabilities and norms) corresponding to the data item in question. For example, common patterns such as endorsements of other peoples thoughts/opinions may be relevant, and can be determined by, for example, implying endorsement through a retweet on Twitter™, conversation between people (@mentions), news articles (external link references), hashtags, etc. For example, if it is determined that a user is simply retweeting another user's interest in buying a product, the retweet user may be discard as a lead. Additionally, it has been found that excessive usage of hashtags typically relates to an indication of product endorsement but not necessarily a purchase intent and, therefore, purchase leads may be discarded where posts consist of, for example, more than 3 hashtags, though these leads may be advocate leads.

Domain specific scoring applies the taxonomy to identify mentions of product names from social posts. Once product mentions are identified, that information may be used to score a lead. This is based on the presumption that an actual mention of the make or model of a product is a strong indication of intent and leads to the inference of the buying stage of the consumer (e.g., exploratory vs research stage). For example, if the data item is “Iphone5 or Samsung Galaxy, which one do you all think?”, the mention of two specific phone models may be considered a clear indication of the seriousness of the user in buying a phone and this information may be taken into account for scoring the lead. Further, a mention of a brands' social account (i.e. handle) may be considered. So, for example, if a user expresses “I hate my phone it is awful”, the user may not be considered a lead but if the user expresses “I hate @Te/Co it is awful”, that user may be identified as a customer service lead for the telecom company.

Increasing occurrences of slangs (e.g., LOL, OMG, etc.) and abuses have been found indicate sarcasm and frustration more than purchase intent. Therefore, data items with these phrases may be discarded as leads for being unreliable indicators. For example “I need a new car <swear word or internet slangs>” may be discarded as a lead. A list of slangs and common swear-words may be used to identify and handle the slangs/abuses.

The resulting score on the basis of the foregoing may be generated and linked to the data item stored on the scored item database. The score may be quantitative (e.g., on a scale of 1 to 100, for example) or qualitative (e.g., “weak”, “strong”, “neutral”).

Referring now to FIG. 4, an exemplary user interface for use by a business is shown. The business may subscribe to the system in connection with one or more of the predefined topics. For example, an automotive business may subscribe to receive leads in respect of an automotive vertical.

Upon a business accessing the web server, the web server may obtain, for the business's particular topic, a list of a predefined number of the highest scoring items from the scored item database. For each such item, the business may access a detail screen, as depicted in FIG. 4.

In the detail screen, the business may visualize the information relating to the data item (i.e., the message disseminated, the date disseminated, medium disseminated through) and identifying information relating to the lead (e.g., username, handle, profile picture). Additionally, the detail screen may provide a mechanism to engage with the lead, such as by retweeting or replying to the lead via the particular medium. Any other information in respect of the data item or its corresponding lead may also be provided to the business.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for scoring a lead for engagement through a web-enabled medium, the method comprising:
(a) identifying, in a data item disseminated by a user via the web-enabled medium, an intent by semantically analysing the data item and verifying whether the semantically analysed data item matches a pattern model for a topic;
(b) assigning a score to the lead based at least on the intent.

2. The method of claim 1, further comprising:
(a) assigning the score to the lead further based on an analysis of historical data items disseminated by the user.

3. The method of claim 2, further comprising:
(a) assigning the score to the lead further based on an analysis of the user's available biographical information and the user's social vicinity.

4. The method of claim 1, wherein the pattern model corresponds to a matching rule representing at least one regular expression.

5. The method of claim 4, wherein semantically analysing the data item comprises obtaining semantic information for the data item by performing tokenisation and semantic annotation of the data item and at least one of:
(a) parts of speech tagging of the data item;
(b) shallow parsing of the data item; and
(c) semantic role labelling of the data item.

6. The method of claim 5, wherein semantically analysing the data item further comprises:
(a) annotating each token in the data item with the semantic information for the data item.

7. The method of claim 6, wherein annotating each token comprises applying bracketed annotation.

8. The method of claim 7, wherein verifying whether the semantically analysed data item matches the pattern model for the topic comprises comparing the bracket annotated data item with the at least one regular expression of the matching rule corresponding to the pattern model data.

9. The method of claim 8, wherein the at least one regular expression of the matching rule is configured to provide simultaneous matching of all semantic information for the data item.

10. The method of claim 4, the topic being a category of lead.

11. A system for scoring a lead for engagement through a web-enabled medium, the system comprising:
(a) an intent identification module linked to the web and configured to:
i. identify, in a data item disseminated by a user via the web-enabled medium, an intent based on a topic by semantically analysing the data item and verifying whether the semantically analysed data item matches a pattern model;
ii. storing, in association with the lead, at least the data item and the identified intent for the data item in a scored items database; and
(b) a lead scoring module, linked to the scored item database, configured to assign a score to the lead based at least on the intent.

12. The system of claim 9, wherein the lead scoring module is configured to assign the score to the lead further based on an analysis of historical data items disseminated by the user.

13. The system of claim 10, wherein the lead scoring module is configured to assign the score further based on an analysis of the user's available biographical information and the user's social vicinity.

14. The system of claim 9, wherein the pattern model corresponds to a matching rule representing at least one regular expression.

15. The system of claim 12, wherein the intent identification module comprises a preprocessing module to tokenise the data item, a semantic annotation unit to semantically annotate the data item, and at least one of:
(a) a parts of speech tagging unit to parts of speech tag the data item;
(b) a shallow parsing unit to shallow parse the data item; and
(c) a semantic role labelling unit to semantic role label the data item,
to provide semantic information about the data item for semantically analysing the data item.

16. The system of claim 13, wherein the intent identification module is configured to semantically analyse the data item by annotating each token in the data item with the semantic information for the data item.

17. The system of claim 14, wherein the intent identification module is configured to annotate each token in the data item by applying bracketed annotation.

18. The system of claim 17, wherein the intent identification module is configured to verify whether the semantically analysed data item matches the pattern model for the topic by comparing the bracket annotated data item with the at least one regular expression of the matching rule corresponding to the pattern model data.

19. The system of claim 18, wherein the at least one regular expression of the matching rule is configured to provide simultaneous matching of all semantic information for the data item.

20. The system of claim 14, the topic being a category of lead.

21. The system of claim 13, wherein the intent identification module is linked to a taxonomy database to provide at least one taxonomy to the semantic annotation unit for semantic annotation.

22. A method for scoring a lead for engagement through a web-enabled medium, the method comprising:
(a) identifying, in a data item disseminated by a user via the web-enabled medium, an intent based on a topic by performing a semantic analysis of the data item; and
(b) assigning a score to the lead based at least on intent.

23. A system for scoring a lead for engagement through a web-enabled medium, the system comprising:
(a) an intent identification module linked to the web and configured to: identify, in a data item disseminated by a user via the web-enabled medium, an intent based on a topic by performing a semantic analysis of the data item; and store the data item and intent for the data item in a scored item database; and
(b) a lead scoring module, linked to the scored item database, configured to assign a score to the lead based at least on the intent.
